(19) United States
(12) Patent Application Publication
(10) Pub. No.: US 2025/0080835 A1
(43) Pub. Date: Mar. 6, 2025

(54) INFORMATION PROCESSING APPARATUS, INFORMATION PROCESSING SYSTEM, INFORMATION PROCESSING METHOD, AND STORAGE MEDIUM

(71) Applicant: CANON KABUSHIKI KAISHA, Tokyo (JP)

(72) Inventor: TOMOAKI KOMIYAMA, Kanagawa (JP)

(21) Appl. No.: 18/816,605

(22) Filed: Aug. 27, 2024

(30) Foreign Application Priority Data
Aug. 31, 2023 (JP) 2023-141687

(51) Int. Cl. H04N 23/60; H04N 23/66

(52) U.S. Cl. CPC H04N 23/64; H04N 23/66

(57) ABSTRACT

An information processing apparatus that performs settings on an external apparatus for controlling an imaging apparatus tracking an object according to a target position of the object to be a tracking target in a captured image receives a setting of a first target position of an object to be a tracking target in a captured image captured by the imaging apparatus. The information processing apparatus acquires a second target position of the object to be the tracking target held in the external apparatus from the external apparatus. The information processing apparatus controls a display unit to display information on a setting of the target position. Based on the first target position and the second target position, the display unit displays the information on the setting of the target position in a first form or a second form different from the first form.

### BACKGROUND

### Field of the Disclosure

The present disclosure relates to an information processing apparatus that remotely operates an imaging apparatus, a method, and a storage medium.

### Description of the Related Art

In the video production field, a technique termed remote production has been increasingly used to capture video images and perform video production by controlling an imaging apparatus from a remote location without on-site operation.

According to this technique, a camera operator operates a controller via a network to remotely perform various settings regarding imaging on an imaging apparatus and a control apparatus controlling the imaging apparatus.

Japanese Patent Application Laid-Open No. 2023-48874 discusses a method in which a camera operator specifies, via a network, the layout (composition) of an object in an image to be captured by an imaging apparatus and controls the imaging apparatus.

The issue here is that with an increase in the distance between the controller operated by the camera operator and the imaging apparatus, the delay time of communication via the network increases. This delays reflection of a changing result of the settings regarding imaging on the imaging apparatus and the control apparatus controlling the imaging apparatus.

In such a situation, the camera operator may erroneously recognize that the settings regarding imaging have not been changed, and this may cause an excessive operation.

### SUMMARY

Some embodiments of the present disclosure are directed to providing an information processing apparatus capable of, in a case where a camera operator performs an operation of controlling an imaging apparatus from a remote location, notifying the camera operator of information on a setting change state.

According to an aspect of the present disclosure, an information processing apparatus that performs settings on an external apparatus for controlling an imaging apparatus tracking an object according to a target position of the object in a captured image includes at least one memory storing instructions and at least one processor. When executing the stored instructions, the at least one processor cooperates with the at least one memory to receive a setting for a first target position of an object in a captured image captured by the imaging apparatus, acquire a second target position of the object held in the external apparatus from the external apparatus, and control, as display control, a display unit to display information on a setting of the target position, wherein based on the first target position and the second target position, the display control controls the display unit to display the information on the setting of the target position in a first form or a second form different from the first form.

Further features of various embodiments will become apparent from the following description of exemplary embodiments with reference to the attached drawings.

### BRIEF DESCRIPTION OF THE DRAWINGS

FIG. 1 is a diagram illustrating a remote operation system according to a first exemplary embodiment.

FIG. 2 is a block diagram illustrating configurations of a camera, an edge artificial intelligence (AI) device, and a personal computer (PC) according to the first exemplary embodiment.

FIG. 3A is a flowchart illustrating an operation of controlling the AI device according to the first exemplary embodiment, and FIG. 3B is a flowchart illustrating an operation of the camera according to the first exemplary embodiment.

FIG. 4 is a diagram illustrating an operation procedure that is performed in response to an operation being performed on the PC according to the first exemplary embodiment.

FIG. 5A is a diagram illustrating an example of a target position mark in the PC according to the first exemplary embodiment, and FIG. 5B is a diagram illustrating an example of the target position mark in the PC according to the first exemplary embodiment.

FIG. 6A is a diagram illustrating an operation procedure of the edge AI device according to the first exemplary embodiment, and FIG. 6B is a diagram illustrating an operation procedure of the PC according to the first exemplary embodiment.

FIGS. 7A to 7E are diagrams illustrating display form changes in the target position mark according to the first exemplary embodiment.

FIG. 8 is a diagram illustrating a remote operation system according to a second exemplary embodiment.

FIG. 9 is a block diagram illustrating configurations of apparatuses according to the second exemplary embodiment.

FIG. 10A is a diagram illustrating an operation procedure of a controller according to the second exemplary embodiment, and FIG. 10B is a diagram illustrating an operation procedure of the controller according to the second exemplary embodiment.

FIG. 11A is a diagram illustrating an example of a target position mark in the controller according to the second exemplary embodiment, FIG. 11B is a diagram illustrating an example of the target position mark in the controller according to the second exemplary embodiment, and FIG. 11C is a diagram illustrating an example of the target position mark in the controller according to the second exemplary embodiment.

FIG. 12 is a diagram illustrating an operation procedure in a display form a change in response to communication latency according to a third exemplary embodiment.

FIG. 13 is a diagram illustrating an operation procedure in a display form change in response to communication latency according to a fourth exemplary embodiment.

FIGS. 14A to 14D are diagrams illustrating display form changes in a target position mark according to the fourth exemplary embodiment.

### DESCRIPTION OF THE EMBODIMENTS

### Configuration of Remote Operation System

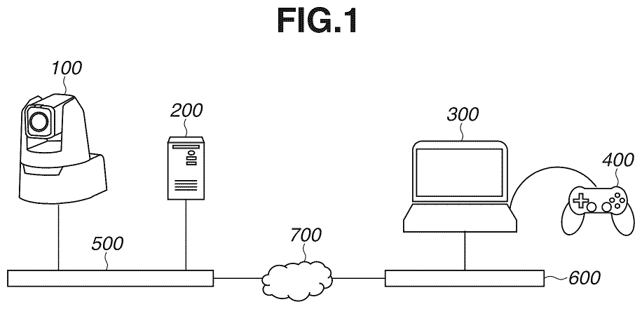

FIG. 1 is a diagram illustrating the configuration of a remote operation system according to a first exemplary embodiment for carrying out the present disclosure.

The remote operation system includes a camera 100, an edge artificial intelligence (AI) device 200, a personal computer (PC) 300, and a controller 400. Although the camera 100 is connected to the edge AI device 200 via a local area network (LAN) 500, some embodiments of the present disclosure are not limited to this. For example, the camera 100 may be connected to the edge AI device 200 by using serial digital interface (SDI) or High-Definition Multimedia Interface (HDMI)®. Similarly, although the controller 400 is connected to the PC 300 (an information processing apparatus) via a LAN 600, some embodiments of the present disclosure are not limited to this. For example, the controller 400 may be connected to the PC 300 by using SDI, HDMI, or Universal Serial Bus video class (UVC).

Further, the LANs 500 and 600 are connected together via the Internet 700, and the apparatuses can communicate with each other.

The camera 100 and the edge AI device 200 are installed at positions physically close to each other, and the PC 300 is installed at a remote location away from the camera 100 and the edge AI device 200.

In this situation, latency, i.e., a propagation delay of communication data (communication delay), can occur in communication between the PC 300 (information processing apparatus) and the camera 100 or the edge AI device 200. A communication delay between the camera 100 and the edge AI device 200 does not occur.

Although the camera 100 and the edge AI device 200 are described as separate apparatuses in the present exemplary embodiment, a configuration in which the camera 100 and the edge AI device 200 are integrated together may be employed. Similarly, although the PC 300 and the controller 400 are described as separate apparatuses, a configuration in which the PC 300 and the controller 400 are integrated together may be employed.

### Configuration of Camera 100

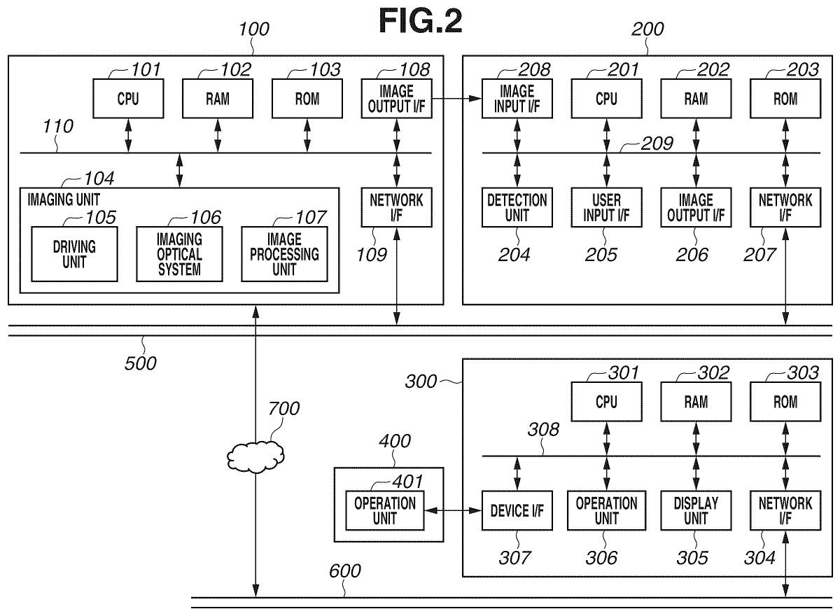

FIG. 2 is a block diagram illustrating the configurations of the camera 100, the edge AI device 200, and the PC 300 according to the present exemplary embodiment.

The camera 100 includes a central processing unit (CPU) 101, a random-access memory (RAM) 102, a read-only memory (ROM) 103, an imaging unit 104, a driving unit 105, an imaging optical system 106, an image processing unit 107, an image output interface (I/F) 108, a network I/F 109, and an internal bus 110 that enables these components to communicate with each other.

The camera 100 outputs a captured image captured by the imaging unit 104 to an external apparatus via each network or an image cable (not illustrated). The camera 100 has a tracking function to automatically track an object.

The CPU 101 performs overall control of the camera 100.

The RAM 102 is a storage device, such as a dynamic random-access memory (DRAM), and temporarily stores a computer program that is executed by the CPU 101. Into the RAM 102, an operating system (OS), various programs, and various pieces of data are loaded. The RAM 102 provides a work area that is used by the CPU 101 executing processing. The RAM 102 is also used as a work area for the OS and the various programs.

The ROM 103 is a non-volatile storage device typified by a flash memory, a hard disk drive (HDD), a solid-state drive (SSD), or a Secure Digital (SD) card. The ROM 103 is used as a permanent storage area that stores programs, such as the OS, the various programs, and the various pieces of data, for the CPU 101 to control the camera 100 and is also used as a storage area for various pieces of short-term data.

The imaging unit 104 includes the driving unit 105, the imaging optical system 106, and the image processing unit 107. The imaging direction of the camera 100 is changeable by the driving unit 105 driving a pan/tilt (PT) mechanism. A zoom (Z) operation to change the imaging angle of view of the camera 100 can be performed by the driving unit 105 driving the imaging optical system 106 in the optical axis direction.

The driving unit 105 drives the imaging unit 104 to obtain a pan value, a tilt value, and a zoom value according to a PTZ driving command from the CPU 101.

The imaging optical system 106 is a group of lenses that collects light from an object on an imaging surface of an imaging sensor. For example, the imaging optical system 106 includes a zoom lens, a focus lens, and a blur correction lens. The zoom value is changeable by the imaging optical system 106 driving in the optical axis direction. The imaging sensor (not illustrated) of the imaging unit 104 captures an image of an object and generates a captured image. The imaging sensor (not illustrated) of the imaging unit 104 converts light that has been reflected from an object and collected by the imaging optical system 106 into an electric signal pixel by pixel. An amplifier (not illustrated) amplifies the electric signal converted by the imaging sensor and outputs the electric signal to the image processing unit 107. Examples of the imaging sensor include a charge-coupled device (CCD) sensor or a complementary metal-oxide-semiconductor (CMOS) sensor.

The image processing unit 107 converts the electric signal amplified by the amplifier (not illustrated) into a predetermined format, compresses the electric signal where necessary, and transfers the electric signal to the RAM 102. The image processing unit 107 also performs image quality adjustment in image capturing acquisition, and performs a cropping process to clip a predetermined region of image data.

These processes are performed according to instructions from an external apparatus, such as the edge AI device 200 or the PC 300 via the network I/F 109.

While, in the present exemplary embodiment, the imaging unit 104 and the driving unit 105 are described as being integrated together, the imaging unit 104 and the driving unit 105 may be separate units attachable to and detachable from each other as units in a camera of which the imaging direction is changed with a pan head holding the camera. Further, while, in the present exemplary embodiment, the imaging unit 104 and the imaging optical system 106 are described as being integrated together, the imaging unit 104 and the imaging optical system 106 may be separate units attachable to and detachable from each other as units in an interchangeable lens camera.

The image output I/F 108 is an interface to output a captured image to outside and includes an SDI terminal or an HDMI® terminal. The image output I/F 108 is connected to an image input I/F 208 of the edge AI device 200.

The network I/F 109 is an I/F to connect to the LAN 500 and communicates with an external apparatus, such as the edge AI device 200 or the PC 300, via a communication medium based on Ethernet®. While, in the present exemplary embodiment, the camera 100 is remotely controlled via the network I/F 109, the camera 100 may be remotely controlled via another I/F, such as a serial communication I/F (not illustrated).

### Configuration of Edge AI Device 200

FIG. 2 is the block diagram illustrating the configurations of the camera 100, the edge AI device 200, and the PC 300 according to the present exemplary embodiment.

The edge AI device 200 includes a CPU 201, a RAM 202, a ROM 203, a detection unit 204, a user input I/F 205, an image output I/F 206, a network I/F 207, an image input I/F 208, and an internal bus 209 that enables these components to communicate with each other.

The CPU 201 performs overall control of the edge AI device 200.

The RAM 202 is a storage device, such as a DRAM, and temporarily stores a computer program that is executed by the CPU 201. Into the RAM 202, an OS, various programs, and various pieces of data are loaded. The RAM 202 provides a work area that is used by the CPU 201 executing processing. The RAM 202 is also used as a work area for the OS and the various programs.

The ROM 203 is a non-volatile storage device typified by a flash memory, an HDD, an SSD, or an SD card. The ROM 203 is used as a permanent storage area that stores programs, such as the OS, the various programs, and the various pieces of data, for the CPU 201 to control the edge AI device 200 and is also used as a storage area for various pieces of short-term data.

The detection unit 204 estimates the position of an object or the presence or absence of an object from an image received via the image input I/F 208. For example, the detection unit 204 includes a calculation device that is specialized in image processing or a detection process, such as a graphics processing unit (GPU). The detection unit 204 includes a trained model created using a machine learning technique, such as deep learning. Although a GPU is generally effective for use in a learning process, an equivalent function may be achieved by a reconfigurable logic circuit, such as a field-programmable gate array (FPGA). Also, the CPU 201 may perform the processing of the detection unit 204. While, in the present exemplary embodiment, an object is described as a person, some embodiments are not limited to this. An object may be a physical body other than a person, such as a vehicle or a dog.

The user input I/F 205 (a reception unit) is an interface to connect to a mouse, a keyboard, and another input device and includes a Universal Serial Bus (USB) terminal.

The image output I/F 206 is an interface to output a setting information screen of the edge AI device 200.

The network I/F 207 is an I/F to connect to the LAN 500 and communicates with an external apparatus, such as the camera 100 or the PC 300, via a communication medium based on Ethernet.

The image input I/F 208 is an interface to receive a captured image from the camera 100 and includes an SDI terminal or an HDMI terminal.

The edge AI device 200 executes detection using AI on a captured image delivered from the camera 100 and detects an object. Further, the edge AI device 200 transmits, via the LAN 500, a control signal to track the object and changes the imaging direction of the camera 100 based on a result of the detection of the object in the acquired captured image.

The camera 100 may include the control functions that are performed by the edge AI device 200.

### Configuration of PC 300

FIG. 2 is the block diagram illustrating the configurations of the camera 100, the edge AI device 200, and the PC 300 according to the present exemplary embodiment.

The PC 300 includes a CPU 301, a RAM 302, a ROM 303, a network I/F 304, a display unit 305, an operation unit 306, a device I/F 307, and an internal bus 308 that enables these components to communicate with each other.

The CPU 301 performs entire control of the PC 300. The CPU 301 performs control regarding display (display control) on the display unit 305, which is described below.

The RAM 302 is a storage device, such as a DRAM and temporarily stores a computer program that is executed by the CPU 301. Into the RAM 302, an OS, various programs, and various pieces of data are loaded. The RAM 302 provides a work area that is used by the CPU 301 to execute processing. The RAM 302 is also used as a work area for the OS and the various programs.

The ROM 303 is a non-volatile storage device typified by a flash memory, an HDD, an SSD, or an SD card. The ROM 303 is used as a permanent storage area that stores programs, such as the OS, the various programs, and the various pieces of data, for the CPU 301 to control the PC 300 and is also used as a storage area for various pieces of short-term data. While, in the present exemplary embodiment, the ROM 303 includes an SSD, some embodiments are not limited to this.

The network I/F 304 is an I/F to connect to the LAN 600 and communicates with an external apparatus, such as the camera 100 or the edge AI device 200 via a communication medium based on Ethernet. The term “communication” refers to the transmission and reception of a control command to and from the camera 100 or the PC 300 or the reception of a captured image from the camera 100.

The display unit 305 displays a captured image captured by the camera 100 and a setting screen of the PC 300. While, in the present exemplary embodiment, the PC 300 includes a display unit, some embodiments are not limited to this configuration. For example, a configuration in which a display monitor that displays a captured image and a controller are each present may be employed.

The operation unit 306 is an interface to receive an operation performed on the PC 300 by a user. Examples of the operation unit 306 include a button, a dial, a joystick, and a touch panel. For example, based on an operation of the user, the operation unit 306 receives an input of an instruction to control the pan and tilt of the camera 100.

The device I/F 307 is an interface to connect to an input device and includes a USB terminal. In the present exemplary embodiment, the device I/F 307 is used as a connection I/F with the controller 400 illustrated in FIG. 1.

The PC 300 acquires a captured image output from the camera 100 via the Internet 700 and displays the captured image. Further, the PC 300 receives a setting operation or the like for settings regarding object tracking from the user and transmits an instruction to control the edge AI device 200 via the Internet 700, based on the content of the operation.

Specific examples of the settings regarding object tracking include settings regarding the determination of a tracking target, the angle of view and the imaging direction of the captured image, and the position of an object in the captured image.

In the setting operation, the settings can be performed using a method for directly operating the PC 300 or a method for operating the PC 300 through the controller 400 illustrated in FIG. 1. That is, the settings regarding object tracking may be performed via the operation unit 306 of the PC 300 or may be performed via an operation unit 401 of the controller 400.

In the present exemplary embodiment, the user operates the controller 400 to input tracking settings including various settings for tracking and capturing a tracking target. The description is given of a case in which the controller 400 outputs the input tracking settings to the PC 300.

A method for selecting a person as the tracking target is not limited to a particular method as long as the method can select the face of a person as the tracking target from among one or more detected faces. For example, the PC 300 or the edge AI device 200 may select a face located at the closest coordinates to a target position in a captured image, or may select a person set in advance as the tracking target. While, in the present exemplary embodiment, a description is given of a case in which the tracking target is a person, the tracking target is not limited to a person, and the following description is similarly applicable to a case where the tracking target is other than a person.

Next, the controller 400 is described.

The controller 400 is a controller including an operation unit 401 and is a user interface, such as a keyboard or a multidirectional input stick controller, that enables an operation on the camera 100. In the present exemplary embodiment, the user performs settings regarding object tracking using a joystick of the controller 400. The controller 400 connects to the device I/F 307 and transmits information according to an operation of the user to the PC 300.

While, in the present exemplary embodiment, the controller 400 and the PC 300 are described as separate apparatuses, the operation unit 306 of the PC 300 may perform the processing of the controller 400.

With the remote operation system having the above configuration, the camera 100 can automatically track an object using the edge AI device 200. Further, the user can perform various settings regarding object tracking by operating the PC 300 while checking a captured image displayed on the PC 300.

Although the outline of the operation of the remote operation system (information processing system) has been described, the details of the basic operations of the apparatuses and the characteristic operations according to some embodiments of the present disclosure will be described below.

### Descriptions of Basic Operations of Apparatuses

### (Operation of Camera 100 Which Tracks Object Detected by Edge AI Device 200)

Next, with reference to flowcharts, the operations of the apparatuses are described regarding the basic operation of the remote operation system.

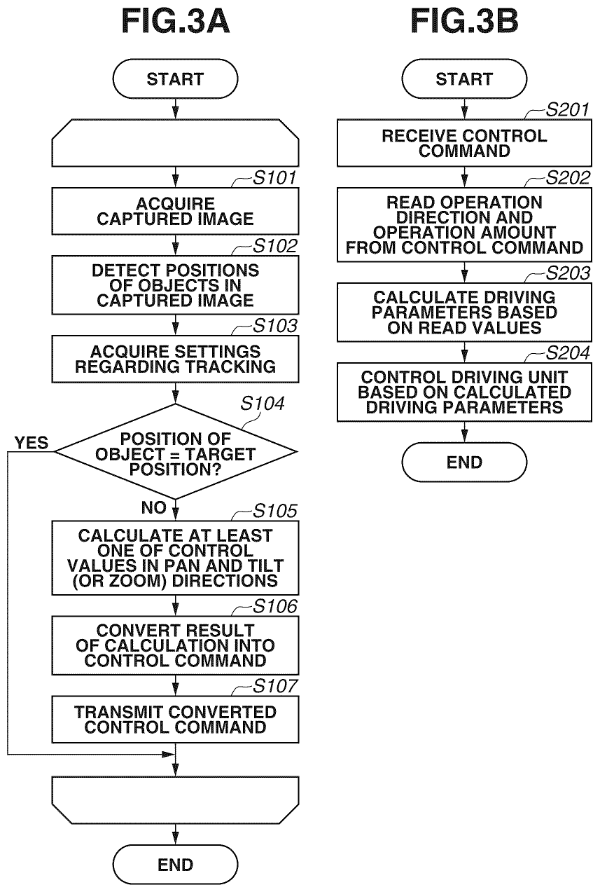

With reference to FIGS. 3A and 3B, a description is given of an operation in which the camera 100 tracks an object detected by the edge AI device 200.

FIG. 3A illustrates the operation procedure of the edge AI device 200, and FIG. 3B illustrates the operation procedure of the camera 100. FIGS. 3A and 3B illustrate a sequential procedure in which the camera 100 is controlled according to the position of an object detected from a captured image by the edge AI device 200 and settings regarding tracking. The term “settings regarding tracking” refer to information on an object that is a tracking target selected from among one or more objects, and the layout (target position) of the object as the tracking target in the captured image.

With reference to the procedure in FIG. 3A, the operation of the edge AI device 200 is described.

FIG. 3A illustrates loop processing in which the edge AI device 200 performs control to receive a captured image sequentially transmitted from the camera 100 via the image input I/F 208, identify the positions of an object in the captured image, and automatically track the object as a tracking target. This control procedure starts in response to the edge AI device 200 connecting to the camera 100 via the LAN 500 and the edge AI device 200 acquiring a captured image captured by the camera 100.

In step S101, the CPU 201 of the edge AI device 200 acquires a captured image captured by the camera 100 via the image input I/F 208. The CPU 201 writes the acquired captured image to the RAM 202. The processing proceeds to step S102.

A captured image is sequentially transmitted from the image output I/F 108 of the camera 100 according to a predetermined frame rate, and the CPU 201 sequentially writes the received captured image to the RAM 202.

The captured image may be received via the network I/F 207 and loaded into the RAM 202 within the edge AI device 200.

In step S102, the detection unit 204 detects the position(s) of one or more objects in the captured image. The CPU 201 reads the captured image from the RAM 202 and inputs the captured image to the detection unit 204. The detection unit 204 writes output data containing the detected positions of the objects to the RAM 202. Then, the processing proceeds to step S103.

Specifically, the detection unit 204 receives the captured image as input data and outputs the type of a tracking target object, such as a person, position information on the objects in the captured image, and a score indicating certainty as output data.

In step S103, the edge AI device 200 acquires settings regarding tracking from the PC 300 via the Internet 700 and stores the settings regarding tracking in the RAM 202. For example, the term “settings regarding tracking” refers to information on an object that is selected as a tracking target from among the one or more objects detected in step S102, and information on a target position. For simplicity, in the following description, the object selected as the tracking target is referred to as the “object”.

In step S104, based on the settings regarding tracking stored in the RAM 202 and the position of the object in the captured image detected in step S102 (and target position), the CPU 201 determines whether the position of the object in the captured image and the target position match each other. While, in the present exemplary embodiment, the information on the target position is acquired in step S103, some embodiments are not limited to this.

The information on the target position may be loaded into the RAM 202 by the CPU 201 when the edge AI device 200 starts. For example, the position of the object in the captured image (and target position) when the edge AI device 200 starts may be automatically set at the center of the captured image or at the position at the time when the edge AI device 200 previously ends.

In a case where the CPU 201 determines that the target position and the detected position of the object match each other (YES in step S104), the processes of steps S105 to S107 are skipped. Then, the processing returns to the beginning of the loop processing. In a case where the CPU 201 determines that the target position and the detected position of the object do not match each other (No in step S104), the processing proceeds to step S105.

In step S105, the CPU 201 calculates a position difference between the position of the object detected in step S102 and the target position. Further, the CPU 201 calculates at least one of angular velocities (control values) in the pan and tilt (or zoom) directions according to the calculated difference in such a manner that the position of the detected object matches the target position. The CPU 201 writes a result of the calculation to the RAM 202. Then, the processing proceeds to step S106.

Examples of the specific calculation of the angular velocity include a method for multiplying a certain distance serving as the difference between coordinate values in each of the pan direction and the tilt direction by a predetermined coefficient and further determining the driving direction according to whether the calculated value is positive or negative. These techniques are known techniques and are not described in detail.

The method for tracking the object using the technique for performing control by calculating the driving direction and the velocity is merely an example. Any method for tracking the object, such as a method for tracking the object by calculating the position at which the camera 100 is driven toward the target position, may be used.

In step S106, the CPU 201 converts the result of the calculation in step S105 into a control command in compliance with a protocol determined in advance as a method for controlling the camera 100 and writes the control command to the RAM 202. The processing proceeds to step S107.

In step S107, the CPU 201 reads the control command written to the RAM 202 in step S106. Further, the CPU 201 transmits the control command to the camera 100 via the network I/F 207. The processing returns to the beginning of the loop processing.

With reference to FIG. 3B, a description is given of the control procedure of the camera 100 that is performed by the camera 100 having received the control command from the edge AI device 200. This control procedure starts in response to the camera 100 connecting to the edge AI device 200 via the LAN 500 and receiving the control command from the edge AI device 200.

In step S201, the CPU 101 receives the control command via the network I/F 109.

In step S202, the CPU 101 is notified by the network I/F 109 that communication data, e.g., the control command in this case, has been received. In response to receipt of the notification, the CPU 101 reads values corresponding to the angular velocities in the pan and tilt directions from the control command written to the RAM 102 by the network I/F 109. After the CPU 101 reads the control command, the processing proceeds to step S203. In this process, as the angular velocities in the pan and tilt (or zoom) directions, at least one of the values of the angular velocities in the pan direction and the tilt direction (or the zoom direction) may be read.

In step S203, based on the values read in step S202, the CPU 101 calculates driving parameters for panning and tilting the camera 100 at a desired velocity in a desired direction. The processing proceeds to step S204. Specifically, the driving parameters are parameters for controlling motors (not illustrated) in the pan direction and the tilt direction included in the driving unit 105, and the CPU 101 may convert an operation amount value included in the received control command into the driving parameters with reference to a conversion table held in the ROM 103 in advance.

In step S204, the CPU 101 controls the driving unit 105 based on the driving parameters calculated in step S203. Then, the processing ends. The driving unit 105 drives the camera 100 based on the parameters, whereby the camera 100 changes the imaging direction, i.e., performs a pan/tilt operation.

Based on the control procedure illustrated in FIG. 3B, the imaging direction of the camera 100 is changeable based on the control command acquired from the edge AI device 200. While, in the present exemplary embodiment, the control command regarding the angular velocities in the pan direction and the tilt direction is acquired from the edge AI device 200, acquisition of the control command is not limited to this. For example, the driving unit 105 may drive the imaging optical system 106 based on a control command regarding the zoom value to change the zoom value.

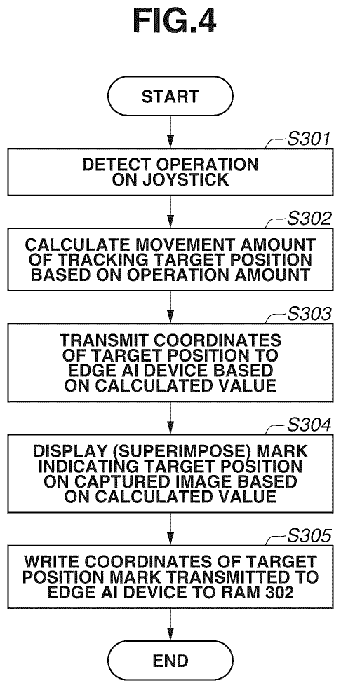

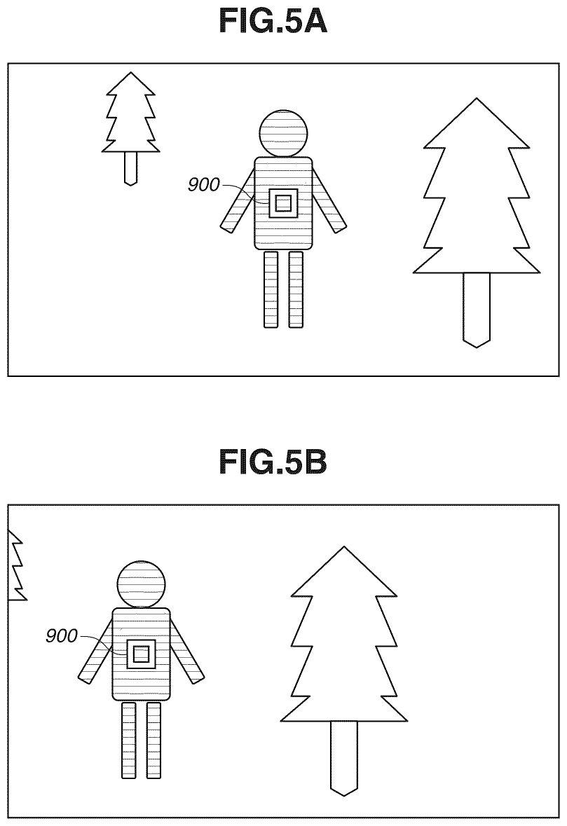

With reference to FIGS. 4, 5A, and 5B, a description is given of the operation procedure when the PC 300 performs settings regarding object tracking for the edge AI device 200.

FIG. 4 illustrates the operation procedure of the PC 300. A description is given of the procedure in which the PC 300 transmits coordinate information (target position) indicating a position in a captured image at which an object is to be laid out when object tracking is performed. This control procedure starts in response to receipt of an operation of the user.

In step S301, the CPU 301 of the PC 300 detects an operation on the joystick of the controller 400 performed by the user via the device I/F 307 and acquires the operation direction and the operation amount of the joystick from the device I/F 307. After the detection of the operation of the user and acquisition of the operation direction and the operation amount of the joystick, the processing proceeds to step S302.

While, in the present exemplary embodiment, the joystick is described as a joystick that is designed to provide an analog output and uses voltages output from variable resistors provided for the pan direction and the tilt direction, some embodiments are not limited to this. For example, an operation may be performed by clicking or touching a graphical user interface (GUI) displayed on the display unit 305, using a mouse or a keyboard. The controller 400 quantizes a voltage input from the joystick in a predetermined sampling cycle using an analog-to-digital (A/D) conversion unit (not illustrated) and outputs a result of the quantization as information corresponding to the operation amount to the device I/F 307.

The A/D conversion unit quantizes a value in a predetermined range, such as 0to 1023, as a component in each of the pan direction and the tilt direction according to the operation amount.

In step S302, based on the operation direction of the joystick and the information on the quantized operation amount that have been acquired in step S301, the CPU 301 calculates a movement amount of a coordinate position (target position) indicating a position in a captured image at which an object is to be laid out. The CPU 301 writes a result of the calculation to the RAM 302. The processing proceeds to step S303.

With reference to FIG. 5A, a description is given of the target position in tracking the object.

FIG. 5A illustrates a captured image displayed on the display unit 305. In FIG. 5A, an object shaded with lines and a target position mark 900 serving as a coordinate position (target position) indicating a position in the captured image at which the object is laid out are displayed. The PC 300 periodically receives a captured image from the camera 100 via the network I/F 304 and can display the received image on the display unit 305. The target position mark 900 is a mark indicating the target position in tracking of the object. In response to the movement of the object, the edge AI device 200 transmits control information to the camera 100 in such a manner that the object is laid out at the position of the target position mark 900 on the captured image. Then, the driving unit 105 of the camera 100 drives the camera 100. In FIG. 5A, the target position mark 900 is set at the center of the image.

In the present exemplary embodiment, the user can move the target position mark 900 by operating the joystick of the controller 400. Specifically, the PC 300 calculates the movement amount of the target position mark 900 based on an operation amount and an operation direction of the joystick. The PC 300 transmits a result of the calculation to the edge AI device 200, and the edge AI device 200 controls the imaging direction of the camera 100, whereby the object comes to the position of the target position mark 900 even in a case where the target position mark 900 moves.

FIG. 5B illustrates the captured image after the target position mark 900 has been moved in the left direction from the position in FIG. 5A. In a case where the target position mark 900 set at the center of the image in FIG. 5A has been moved in the left direction, the imaging direction of the camera 100 is changed in such a manner that the object appears at a position on the left of the captured image.

In step S303, based on the value calculated in step S302, the CPU 301 calculates coordinate information on the coordinates of the target position, and transmits the coordinate information to the edge AI device 200 via the network I/F 304. After transmission of the coordinate information to the edge AI device 200 by the PC 300, the processing proceeds to step S304. The transmitted coordinate information is held in the RAM 202 in the edge AI device 200 and referred to as the target position in step S103 in FIG. 3A by the CPU 201. In the present exemplary embodiment, during the user operation of the joystick, the CPU 301 continues to calculate and transmit the coordinate information on the coordinates of the target position. With this configuration, the target position for object tracking is adjustable in the edge AI device 200.

In the present exemplary embodiment, communication latency (a communication delay) occurs between the edge AI device 200 and the PC 300. Thus, after the transmission of the coordinate information, transmission and reception are performed after a delay time due to the communication delay.

Specifically, the display on the display unit 305 of the PC 300 is immediately updated according to an operation on the controller 400. However, a lag (delay time) occurs after the operation performed on the controller 400 and until the setting regarding the tracking position (target position) of the edge AI device 200 is updated, and the imaging direction of the camera 100 starts to be changed.

In step S304, based on the value calculated in step S302, the CPU 301 calculates coordinate values of the position at which the target position mark 900 is to be superimposed on the captured image, and instructs the display unit 305 to display the target position mark 900 in a superimposed manner at the position of the coordinate values on the captured image.

In step S305, the CPU 301 writes to the RAM 302 the coordinate values that have been transmitted to the edge AI device 200 and are of the position at which the target position mark 900 is superimposed, and updates the target position information on the target position where the object is laid out.

Based on the operation procedure of the PC 300 and the camera 100, the setting of the tracking position of the camera 100 is changeable according to an operation of the user.

The processes of steps S301 to S305 are processes periodically executed while a program is executed. For example, the processes may be periodically executed at an interval of about several tens of milliseconds.

In this case, immediate response is performed to a user operation performed on the joystick of the controller 400, and a target position transmission process and a display update process are successively performed based on the operation direction or the operation amount.

### Description of Operation of Changing Display Form of Target Position Mark

As illustrated in FIGS. 5A and 5B, when the target position has been changed, due to a communication delay between the edge AI device 200 and the PC 300, transmission of information on a new target position and changing in the imaging direction are performed after a delay time due to the communication delay. In a case where such a delay time occurs, the user may erroneously recognize that the target position has not been changed, and this may cause an excessive operation.

In the situation where a delay time occurs as described above, a message indicating that an instruction to change the target position changed by the user has been transmitted to the edge AI device 200 is displayed on the display unit 305. That is, in the present exemplary embodiment, the display form is changed based on the information on the target position stored in the RAM 302 of the PC 300 and the information on the target position stored in the RAM 202 of the edge AI device 200. Specifically, in the present exemplary embodiment, in a case where a difference between the coordinates of the target position in the RAM 302 of the PC 300 and the coordinates of the target position in the RAM 202 of the edge AI device 200 is greater than a set threshold, the color of the target position mark 900 is changed to red. In a case where the difference is less than or equal to the threshold, the color of the target position mark 900 is changed to white. In the present exemplary embodiment, in a case where the difference between the coordinates of the target position in the RAM 302 of the PC 300 and the coordinates of the target position in the RAM 202 of the edge AI device 200 is less than or equal to the predetermined threshold, it is determined that these target positions match each other. In the present exemplary embodiment, during the user operation of the controller 400, the CPU 301 continues to update the coordinates of the target position held in the RAM 302. Similarly, the CPU 301 continues to transmit the updated coordinates of the target position to the edge AI device 200. In response to acquiring of the coordinates of the target position, the edge AI device 200 updates the coordinates of the target position held in the RAM 202. In a case where the edge AI device 200 can communicate with the PC 300 via the Internet 700, the edge AI device 200 continues to transmit the coordinates of the target position held in the RAM 202 to the PC 300.

In the present exemplary embodiment, the set threshold is set in a circular range centered at the target position stored in the RAM 302. For example, the range of 2% of the area of the display unit 305 centered at the target position stored in the RAM 302 is set as the threshold. In a case where the coordinates of the target position stored in the RAM 202 fall within the range of 2% of the area of the display unit 305 from the coordinates of the target position stored in the RAM 302 on the display unit 305, the color of the target position mark 900 is changed. Some embodiments, however, are not limited to this. For example, the threshold may be set centered at the coordinates of the target position stored in the RAM 202. The threshold may not be a threshold based on the area of the display unit 305. Also, the threshold may be decreased according to the magnitude of the zoom value, whereby the threshold is changed according to the distance from the actual captured physical body.

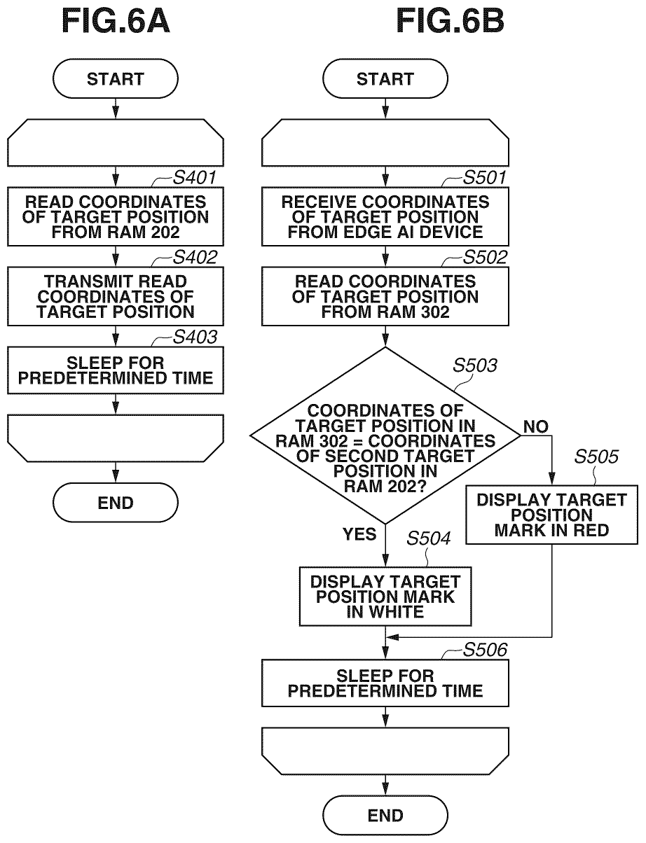

With reference to FIGS. 6A and 6B, a description is given of an operation of changing the display form of the information (target position mark 900) regarding the target position according to the coordinates of the target position held in the RAM 202 in a case where the information (target position mark 900) regarding the target position is displayed on the display unit 305.

The operation procedure of the edge AI device 200 illustrated in FIG. 6A is described. FIG. 6A is the processing procedure in which the edge AI device 200 transmits the coordinates of the target position held in the RAM 202 to the PC 300. The CPU 201 in the edge AI device 200 reads the target position that is held in the RAM 202 in the edge AI device 200 and is referred to in step S103 in FIG. 3A, and successively transmits the target position to the PC 300.

In step S401, the CPU 201 reads the coordinates of the target position in object tracking held in the RAM 202.

In step S402, the CPU 201 transmits the read coordinates of the target position to the PC 300 via the network I/F 207.

In step S403, the CPU 201 sleeps for a predetermined time. Then, the processing returns to step S401.

When the PC 300 and the edge AI device 200 can communicate with each other via the Internet 700, the coordinates of the target position held in the RAM 202 are successively transmitted to the PC 300 by repeating the above processing.

A description is given of the operation procedure that is performed by the PC 300 when the display form of the information (target position mark 900) on the target position displayed on the display unit 305 is changed according to the coordinates of the target position held in the RAM 202. FIG. 6B illustrates the process in which the PC 300 receives the coordinates of the target position from the edge AI device 200, and a result of a user operation performed on the target position via the controller 400 is displayed on the display unit 305 of the PC 300.

In step S501, the CPU 301 receives the coordinates of the target position transmitted from the edge AI device 200 in step S402 in FIG. 6A via the network I/F 304. Then, the processing proceeds to step S502.

In step S502, the CPU 301 reads the coordinates of the target position written to the RAM 302 in step S305 in FIG. 4. Then, the processing proceeds to step S503. That is, the CPU 301 reads the coordinates of the target position held in the RAM 302.

In step S503, the CPU 301 compares the coordinates of the target position held in the RAM 202 received in step S501 and the coordinates of the target position held in the RAM 302 in step S502. In a case where the coordinates match each other (YES in step S503), the processing proceeds to step S504. In step S504, the CPU 301 instructs the display unit 305 to display the target position mark 900 being displayed on the display unit 305 in white. In a case where the coordinates do not match each other (NO in step S503), the processing proceeds to step S505. In step S505, the CPU 301 instructs the display unit 305 to display the target position mark 900 being displayed on the display unit 305 in red.

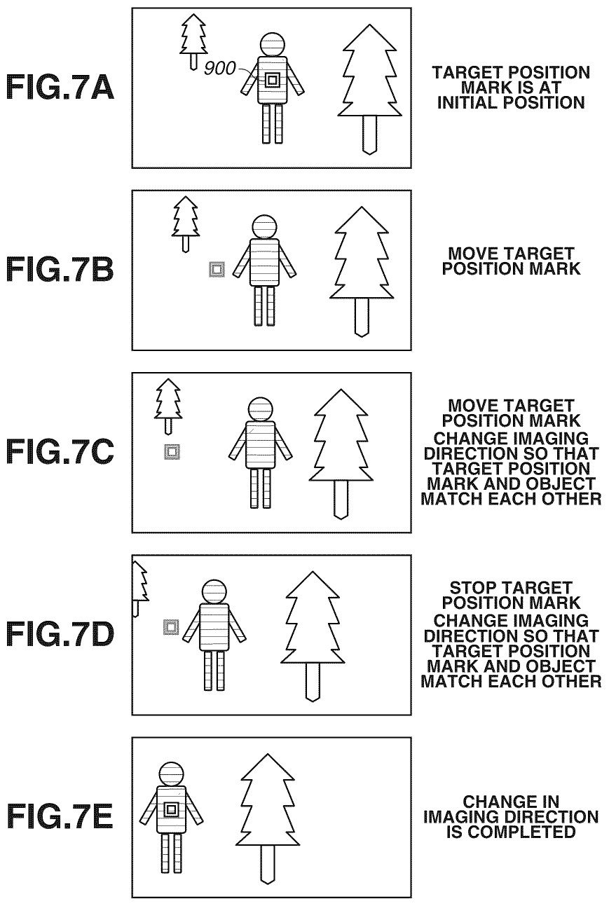

With reference to FIGS. 7A to 7E, a description is given of the state of the image displayed on the display unit 305 in changing of the display color of the target position mark 900.

FIGS. 7A to 7E chronologically illustrate the contents displayed on the display unit 305. The description is given of a case in which the user changes the target position by operating the controller 400 from FIG. 7B to FIG. 7C.

FIG. 7A illustrates the display content when the object is captured at the position of the target position mark 900. FIG. 7B illustrates the display content when the user operates the target position mark 900. FIG. 7C illustrates the display content in the middle of changing the imaging direction of the camera 100 according to the movement of the target position mark 900. FIG. 7D illustrates the display content when the operation of changing the target position mark 900 is completed. FIG. 7E illustrates the display content when the change in the imaging direction has been completed, and the object is captured at the position of the target position mark 900 again.

FIGS. 7A and 7E correspond to the display contents when the coordinates of the pieces of target position information match each other in step S504, and illustrate the states in which the target position mark 900 is displayed in white.

FIGS. 7B, 7C, and 7D correspond to the display contents when the coordinates of the pieces of target position information do not match each other in step S505, and illustrate the states in which the target position mark 900 is displayed in red (shaded in FIGS. 7B, 7C, and 7D).

During the state in which the coordinates do not match each other, the PC 300 can determine that the edge AI device 200 does not acquire the target position due to communication latency.

The purpose of the above processing is as follows. By using the difference in the target position due to the communication latency, the color of the target position mark is changed during the communication latency, whereby the user recognizes the situation where the communication latency occurs. This prevents the user from recognizing that the result of the operation performed by the user is not reflected.

On the other hand, in the situation with sufficiently small communication latency or when a change in the target position is slight, the time period of when the coordinates of the target positions do not match each other is short.

In such a situation, if the process of changing the color of the target position mark 900 is performed while the coordinates do not match each other, there is a possibility that the color of the target position mark 900 quickly and alternately changes and the target position mark 900 seems to be blinking.

Accordingly, in the present exemplary embodiment, control is performed in such a manner that in a case where the difference between the coordinates of the target position held in the RAM 302 and the coordinates of the target position held in the RAM 202 is greater than the predetermined threshold, the color of the target position mark 900 is changed. Some embodiments, however, are not limited to this. Also, for example, control may be performed in such a manner that the color of the target position mark 900 is changed for the first time when the situation where the coordinates do not match each other continues for a predetermined time. Yet also, the predetermined threshold may not be set, and control may be performed in such a manner that the color of the target position mark is changed for the first time when the coordinates of the target position held in the RAM 302 and the coordinates of the target position held in the RAM 202 completely match each other.

In step S506, the CPU 301 sleeps for a predetermined time. Then, the processing returns to the beginning.

As described above, the color of the target position mark 900 is changed according to a result of the comparison between the coordinates of the target positions, whereby the user can visually recognize that communication latency occurs.

While, in the present exemplary embodiment, a description has been given of the case in which communication latency occurs. Also, for example, the present exemplary embodiment is also applicable to an operation system where high latency occurs due to processing other than communication, such as a detection process in an edge device or image signal processing, which is also effective.

While, in the present exemplary embodiment, a description has been given of a case in which the color of the target position mark 900 is changed as a change in the display form of the target position mark 900, a method for informing the user by changing the shape or the fill pattern of the target position mark 900 can also be employed.

Further, a method for informing the user that communication latency occurs using communication latency time information, a warning sentence, a sound, or the vibration of the controller 400 in addition to the target position mark 900 can also be employed. While, in the present exemplary embodiment, the edge AI device 200 controls the camera 100 to track the object and transmits the target position information to the PC 300, some embodiments are not limited to this. For example, a configuration in which the camera 100 has the functions of the edge AI device 200 may be employed.

In the first exemplary embodiment, the display form of the target position mark is changed in accordance with the edge AI device 200 and the PC 300.

In a second exemplary embodiment, unlike the first exemplary embodiment, a controller 800 having a joystick and a monitor is used instead of the PC 300. Further, in the present exemplary embodiment, the display form of a rectangle frame (object frame) indicating an object detected by AI instead of a target position mark is changed. In the first exemplary embodiment, an operation on the joystick is received via the device I/F 307 of the PC 300. In the present exemplary embodiment, the controller 800 directly reads the operation amount of the joystick included in the controller 800 and changes a target position.

In the present exemplary embodiment, components that perform processes similar to those in the first exemplary embodiment are designated by the same signs, and the redundant descriptions are omitted.

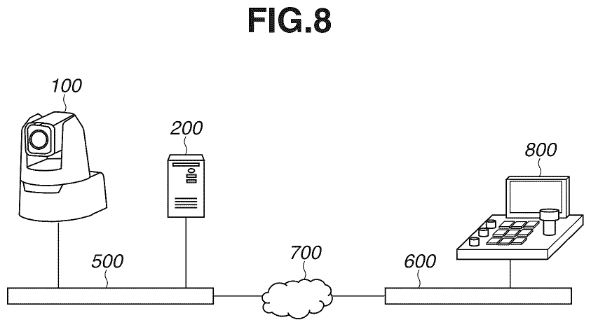

FIG. 8 is a diagram illustrating a configuration of a remote operation system according to the second exemplary embodiment.

In the first exemplary embodiment, the PC 300 is connected to the LAN 600. In the second exemplary embodiment, the controller 800 is connected to the LAN 600.

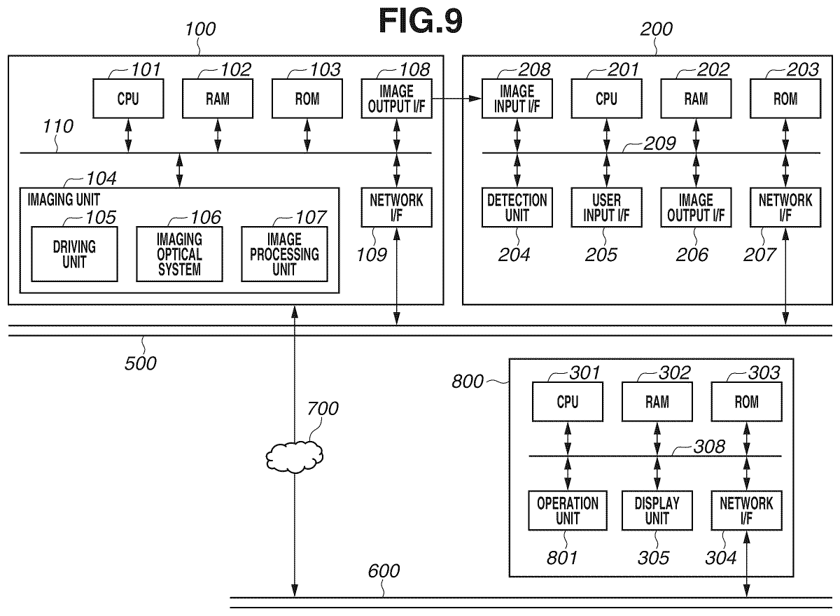

With reference to FIG. 9, the internal configurations of apparatuses according to the second exemplary embodiment are described. FIG. 9 is a block diagram illustrating configurations of apparatuses according to the second exemplary embodiment.

The internal configurations of the camera 100 and the edge AI device 200 are equivalent to those in the first exemplary embodiment, and the redundant descriptions are omitted.

The controller 800 includes a CPU 301, a RAM 302, a ROM 303, a network I/F 304, a display unit 305, an operation unit 801, and an internal bus 308 that enables these components to communicate with each other.

The operation unit 801 is a member, such as a joystick included in the main body of the controller 800, for example. Specific examples of the joystick include a joystick that is designed to provide an analog output and uses voltages output from variable resistors provided for the pan direction and the tilt direction, similarly to the first exemplary embodiment.

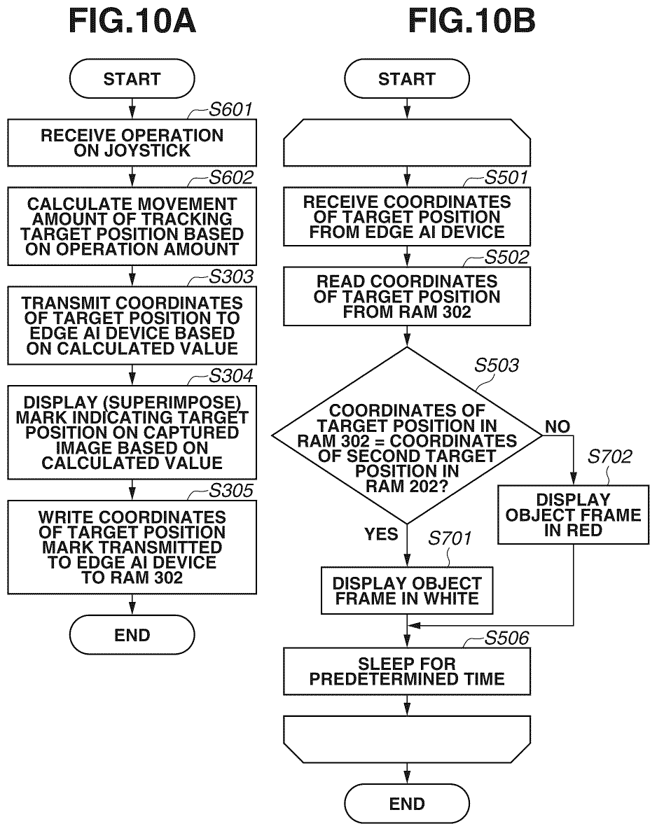

With reference to FIGS. 10A and 10B, the operation of the controller 800 according to the present exemplary embodiment is described.

FIG. 10A illustrates the operation procedure that is performed by the controller 800 when the user operates the joystick of the controller 800.

In the first exemplary embodiment, the operation amount of the joystick is received via the device I/F 307 of the PC 300. In the present exemplary embodiment, the controller 800 directly reads the operation amount of the joystick included in the controller 800. This method is described below.

In step S601, the controller 800 receives an operation on the joystick.

Specifically, the operation unit 801 quantizes a voltage input from the joystick in a predetermined sampling cycle using an A/D conversion unit (not illustrated) and writes a result of the quantization and information on the operation direction to the RAM 302 within the controller 800.

The CPU 301 reads the quantized value corresponding to the operation amount and the information on the operation direction that are written to the RAM 302.

In step S602, based on the operation direction and the operation amount of the joystick that have been read from the RAM 302 in step S601, the CPU 301 calculates the movement amount of a coordinate position (target position) at which an object is continuously to be captured in tracking of the object. Then, the CPU 301 writes the movement amount to the RAM 302.

In the above-described way, similar to the first exemplary embodiment, the target position information is transmitted to the edge AI device 200 according to an operation on the joystick. Steps S303, S304, and S305 are similar to those in the first exemplary embodiment, and the redundant descriptions are omitted.

With reference to FIG. 10B, a description is given of an example in which a form of a target position information to notify the user of the situation of communication latency on the display unit 305 of the controller 800 is changed. Steps S501, S502, S503, and S506 are similar to those in the first exemplary embodiment, and the redundant descriptions are omitted.

In step S701, the CPU 301 instructs the display unit 305 to display an object frame being displayed on the display unit 305 in white.

In step S702, the CPU 301 instructs the display unit 305 to display the object frame being displayed on the display unit 305 in red.

The controller 800 periodically receives information on the object frame indicating the detected object with a rectangle from the edge AI device 200 via the network I/F 304. Further, the controller 800 can display the object frame on the display unit 305 in a superimposed manner on a captured image periodically received from the camera 100.

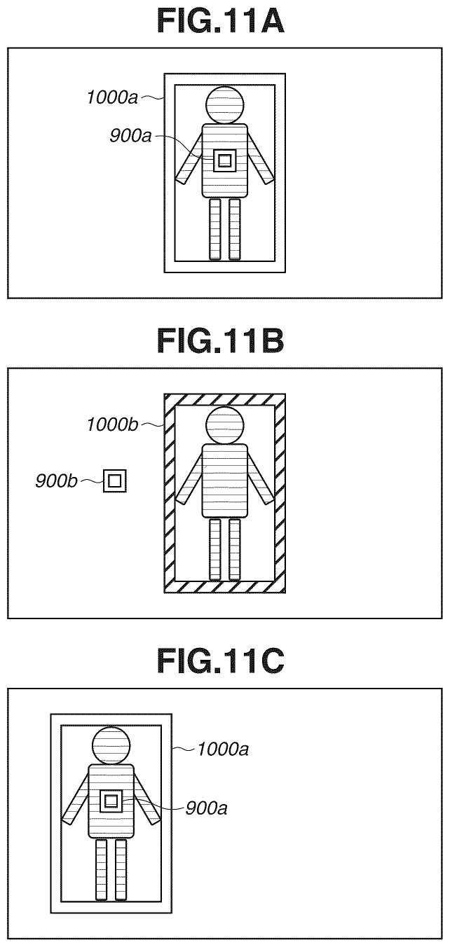

With reference to FIGS. 11A to 11C, a description is given of the state of the image displayed on the display unit 305 in changing of the display color of the object frame. FIGS. 11A to 11C are arranged in chronological order.

FIG. 11A illustrates the situation where the user does not operate the joystick of the controller 800, and a target position mark 900a is at the center of a captured image.

In FIG. 11A, an object frame 1000a received from the edge AI device 200 is superimposed on the captured image.

FIG. 11A illustrates the situation where the object frame 1000a is displayed in white because the coordinates of the target position received in step S501, and the coordinates of the target position read from the RAM 302 in step S502 match each other.

FIG. 11B illustrates the situation where a target position mark 900b is moved by the user operating the joystick of the controller 800.

FIG. 11B illustrates the state in which an object frame 1000b is displayed in red in step S702 based on the determination in step S503 that the coordinates of the target positions do not match each other when the target position mark 900b has been moved.

FIG. 11C illustrates the state in which the target position mark 900b is at the same coordinates as those in FIG. 11B, and a control command has been reflected after communication latency. Since the coordinates of the target position received in step S501 and the coordinates of the target position read from the RAM 302 in step S502 match each other, the object frame 1000a is displayed in white.

As described above, the color of the object frame is changed according to a result of the comparison between the coordinates of the pieces of target position information, whereby the user can visually recognize that communication latency occurs. In the second exemplary embodiment, not only the target position mark but also the detection frame in which an object is detected is displayed, whereby the visibility of an object as a tracking target is improved. This is useful in a case where tracking targets are switched.

While, in the present exemplary embodiment, the color of the object frame is changed. Also, for example, a method for changing the shape or the fill pattern of the frame may be applied.

Communication latency may dynamically change depending on the communication environment. In view of this, switching of enabling and disabling of the display form change control described in the first or second exemplary embodiment according to a situation of the communication latency is also useful.

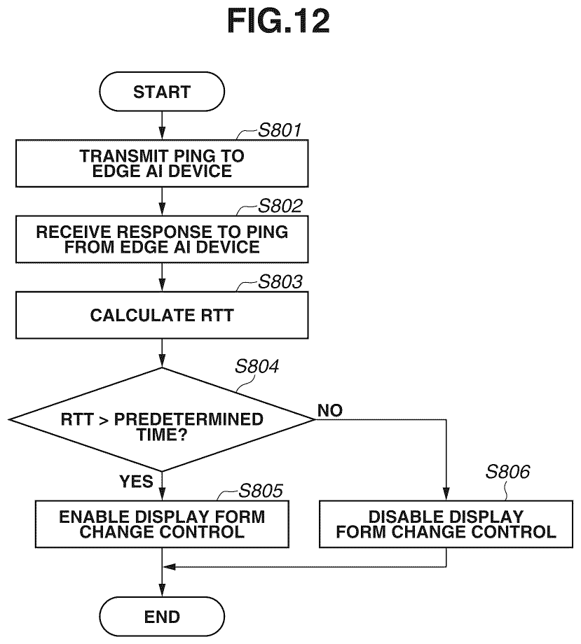

FIG. 12 is a diagram illustrating the procedure of the switching of enabling and disabling of the display form change control according to a communication latency measurement result by the controller 800 according to a third exemplary embodiment. The internal configurations of a remote operation system and apparatuses are similar to those in the second exemplary embodiment.

In step S801, the CPU 301 of the controller 800 transmits a message to the edge AI device 200 via the network I/F 304, using ping that is used to obtain a response time.

In step S802, the CPU 301 receives a response from the edge AI device 200 via the network I/F 304.

In step S803, the CPU 301 calculates a round-trip time (RTT) corresponding to a communication round-trip time, i.e., a communication time. In step S804, the CPU 301 determines whether the RTT is greater than or equal to a predetermined time. While, in the present exemplary embodiment, the CPU 301 calculates the communication time, some embodiments are not limited to this. For example, a communication time acquired from the edge AI device 200 may be used.

In a case where the CPU 301 determines in step S804 that the RTT is greater than the predetermined time (YES in step S804), the processing proceeds to step S805. In step S805, the CPU 301 enables the display form change control. Specifically, the CPU 301 dynamically changes the display form change control to execute the processes of step S503 and the subsequent steps in FIG. 10B.

In a case where the CPU 301 determines in step S804 that the RTT is less than or equal to the predetermined time (NO in step S804), the processing proceeds to step S806. In step S806, the CPU 301 disables the display form change control. Specifically, the CPU 301 dynamically changes the display form change control to skip the processes of step S503 and the subsequent steps in FIG. 10B.

A description has been given of an example where communication latency between the controller 800 and the edge AI device 200 is measured, and determination of whether to change the display form is switched is performed according to a result of the measurement, i.e., an example where an operation mode in which the communication time is factored in and another operation mode in which the communication time is not factored in are switched. Addition of such processing leads to the achievement of automatic prevention of a change in the form in the situation where a change in the display form is not necessary, e.g., the situation where communication latency does not occur.

While, in the present exemplary embodiment, enabling and disabling of the display form change control are dynamically switched according to the RTT. Also, for example, the user may be allowed to set this switching.

Examples of such a method includes a method in which the edge AI device 200 has a web server function, and the operation mode in which communication latency is factored in can be set by the settings of the main body that operates on the server function.

In a case where the user checks a checkbox regarding the operation mode in which communication latency is factored in in the settings of the main body, changing in the form of the target position mark is performed. The configuration in which enabling and disabling of the display form change control are switched according to an instruction given by the user can also be employed.

In the first exemplary embodiment, a description has been given of an example in which the display form of the target position mark is changed based on the target positions stored in the RAM 202 of the edge AI device 200 and the RAM 302 of the PC 300.

In a fourth exemplary embodiment, a description is given of an example in which, in addition to a first target position mark based on the target position stored in the RAM 302 of the PC 300, a second target position mark based on the target position stored in the RAM 202 of the edge AI device 200 is displayed. In the present exemplary embodiment, in a case where the first and second target position marks match each other, the display form of the first target position mark is changed. Specifically, a first target position mark 1300 stored in the RAM 302 and a second target position mark 1400 stored in the RAM 202 are superimposed on a captured image captured by the camera 100.

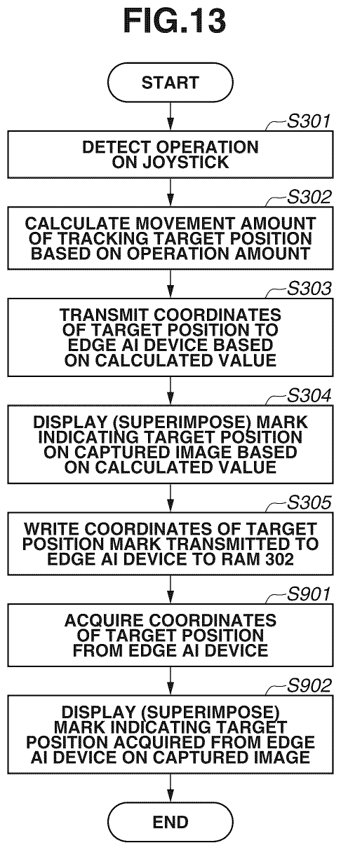

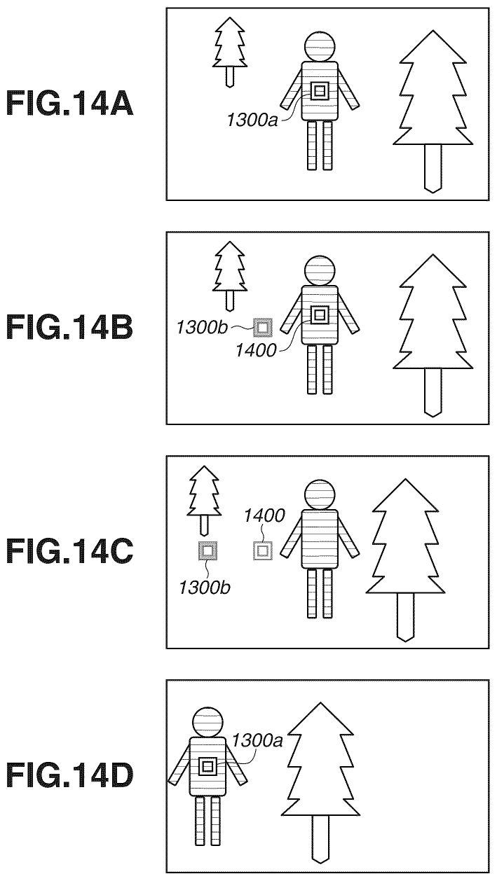

With reference to a flowchart in FIG. 13 and FIGS. 14A to 14D, in the present exemplary embodiment, a description is given of the state of the image displayed on the display unit 305 in changing of the display color of the target position mark.

In the procedure in FIG. 13, the processes of steps S301 to S305 are the same as those in the above-described procedure, and the redundant descriptions are omitted.

In step S901, the PC 300 acquires the coordinates of the target position stored in the RAM 202 from the edge AI device 200.

In step S902, based on the coordinates of the target position acquired in step S901, the CPU 301 controls the display unit 305 to display a mark indicating the target position.

FIGS. 14A to 14D illustrate contents chronologically displayed on the display unit 305. The description is given of a case in which the user changes the target position by operating the controller 400 from FIG. 14B to FIG. 14C. The first target position mark 1300 indicates the target position changed by the user, i.e., the target position stored in the RAM 302, and the second target position mark 1400 indicates the target position stored in the RAM 202.

FIG. 14A illustrates the display content when the positions of the first target position mark 1300 and the second target position mark 1400 match each other. In the present exemplary embodiment, in a case where the first target position mark 1300 and the second target position mark 1400 match each other as illustrated in FIG. 14A, the second target position mark 1400 is not displayed. Some embodiments, however, are not limited to this. For example, the first target position mark 1300 may be displayed in an overlapped manner on the second target position mark 1400. FIG. 14B illustrates the display content when the user operates the first target position mark 1300. FIG. 14C illustrates the display content when the imaging direction of the camera 100 is changed according to the second target position mark 1400 stored in the RAM 202, and the operation of moving the first target position mark 1300 by the user has been completed. FIG. 14D illustrates the display content when the position of the first target position mark 1300 and the position of the second target position mark 1400 match each other by changing of the imaging direction of the camera 100.

A target position mark 1300a and a target position mark 1300b are marks different from each other in color. In a case where the position coordinates in the image of the first target position mark 1300 and the position coordinates in the image of the second target position mark 1400 do not match each other, the target position mark 1300b is displayed in red.

A description has been given of an example in which, based on the target positions stored in the RAM 202 of the edge AI device 200 and the RAM 302 of the PC 300, two target position marks are displayed in a case where the target positions do not match each other. Addition of such processing helps the user to visually recognize how much communication latency occurs on the display unit 305.

While, in the present exemplary embodiment, the target positions match each other, some embodiments are not limited to this. For example, in a case where the target positions approximately match each other to such a degree that the difference between the coordinates of the target positions is less than or equal to the set threshold as illustrated in the first exemplary embodiment, the color of the target position may change. Further, control may be performed in such a manner that in a case where the target positions approximately match each other, the target position mark 1300 or 1400 is not displayed.

According to the present disclosure, when a camera operator performs an operation of controlling an imaging apparatus from a remote location, the camera operator is notified of information on the state of a change in a setting.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-141687, which was filed on Aug. 31, 2023 and which is hereby incorporated by reference herein in its entirety.

What is claimed is:

1. An information processing apparatus that performs settings on an external apparatus for controlling an imaging apparatus tracking an object according to a target position of the object in a captured image, the information processing apparatus comprising:
at least one memory storing instructions; and
at least one processor that, when executing the stored instructions, cooperates with the at least one memory to:
receive a setting for a first target position of an object in a captured image captured by the imaging apparatus;
acquire a second target position of the object held in the external apparatus from the external apparatus; and
control, as display control, a display unit to display information on a setting of the target position,
wherein based on the first target position and the second target position, the display control controls the display unit to display the information on the setting of the target position in a first form or a second form different from the first form.

2. The information processing apparatus according to claim 1,
wherein in a case where a distance between the first target position and the second target position is greater than a predetermined threshold, the display control controls the display unit to display the information on the setting of the target position in the first form, and
wherein in a case where the distance between the first target position and the second target position is less than or equal to the threshold, the display control controls the display unit to display the information on the setting of the target position in the second form.

3. The information processing apparatus according to claim 2, wherein the information on the setting of the target position is a mark indicating the first target position.

4. The information processing apparatus according to claim 2, wherein the information on the setting of the target position is a color of a frame surrounding the object.

5. The information processing apparatus according to claim 1, wherein the display control superimposes the information on the setting of the target position on the captured image.

6. The information processing apparatus according to claim 3,
wherein, when executing the stored instructions, the at least one processor further cooperates with the at least one memory to receive an operation of a user, and
wherein the display control controls display to move the mark indicating the first target position in the captured image, based on the operation of the user.

7. The information processing apparatus according to claim 6, wherein, when executing the stored instructions, the at least one processor further cooperates with the at least one memory to:
calculate a movement amount of the mark indicating the first target position according to an operation amount of the operation of the user,
wherein the display control displays the mark indicating the first target position by moving the mark in the captured image based on the movement amount calculated by the calculation unit.

8. The information processing apparatus according to claim 1, wherein, when executing the stored instructions, the at least one processor further cooperates with the at least one memory to:
calculate a communication time between the external apparatus and the information processing apparatus,
wherein according to the communication time, the display control determines whether to display the information on the setting of the target position in the first form or the second form different from the first form.

9. The information processing apparatus according to claim 8,
wherein the display control has a first operation mode to control, in a case where the communication time is greater than a predetermined time and a distance between the first target position and the second target position is greater than a predetermined threshold, the display unit to display information on the first target position in the first form and to control, in a case where the communication time is greater than the predetermined time and the distance between the first target position and the second target position is less than or equal to the threshold, the display unit to display the information on the first target position in the second form, and a second operation mode to control, in a case where the communication time is less than or equal to the predetermined time, the display unit not to display the information on the first target position in the first form.

10. The information processing apparatus according to claim 1,
wherein the display control superimposes information indicating the first target position and the second target position on the captured image captured by the imaging apparatus, and
wherein in a case where a distance between the first target position and the second target position is less than or equal to a predetermined threshold, the display control controls the display unit to display the information indicating the first target position in the second form.

11. The information processing apparatus according to claim 1, wherein the first form and the second form are different from each other in shape.

12. The information processing apparatus according to claim 1, wherein the first form and the second form are different from each other in color.

13. An information processing system comprising:
an external apparatus configured to control an imaging apparatus having a tracking function for tracking an object; and
an information processing apparatus configured to perform settings on the external apparatus,
wherein the external apparatus includes
at least one first memory storing instructions; and
at least one first processor that, when executing the stored instructions, cooperates with the at least one first memory to:
acquire information on a setting of a target position of an object from the information processing apparatus and set the information on the setting of the target position; and
transmit the information on the setting of the target position,
wherein the information processing apparatus includes
at least one second memory storing instructions; and
at least one second processor that, when executing the stored instructions, cooperates with the at least one second memory to:
receive a setting of a first target position of an object in a captured image captured by the imaging apparatus;
acquire a second target position of the object from the external apparatus; and
control, as display control, a display unit to display information indicating the target position, and
wherein based on the first target position and the second target position, the display control controls the display unit to display the information indicating the target position in a first form or a second form different from the first form.

14. An information processing method for an information processing apparatus that performs settings on an external apparatus for controlling an imaging apparatus having a function for tracking an object, the method comprising:
receiving a setting of a first target position of an object to be a tracking target in a captured image acquired by the external apparatus;
acquiring a second target position of the object from the external apparatus; and
controlling, as display control, a display unit to display information indicating a target position,
wherein based on the first target position and the second target position, the display control performs control to display the information indicating the target position in a first form or a second form different from the first form.

15. A non-transitory computer-readable storage medium storing computer-executable instructions that, when executed by a computer, cause the computer to:
receive a setting of a first target position of an object to be a tracking target in a captured image acquired by an external apparatus;
acquire a second target position of the object from the external apparatus; and
perform control processing to, based on the first target position and the second target position, display information indicating a target position in a first form or a second form different from the first form.
